(19) United States
(12) Patent Application Publication
(10) Pub. No.: US 2009/0111517 A1
(43) Pub. Date: Apr. 30, 2009

(54) Handheld device capable of independently actuating camera and method thereof

(75) Inventor: Wen-Shan Chen, Kaohsiung City (TW)

Correspondence Address: HUDAK, SHUNK & FARINE, CO., L.P.A., 2020 FRONT STREET, SUITE 307, CUYAHOGA FALLS, OH, 44221, US

(73) Assignee: MITAC INTERNATIONAL CORP., TAOYUAN (TW)

(21) Appl. No.: 12/229,733

(22) Filed: Aug. 26, 2008

(30) Foreign Application Priority Data
Oct. 31, 2007 (TW) 096141109

(51) Int. Cl. H04M 1/00

(52) U.S. Cl. 455/556.2; 455/556.1

(57) ABSTRACT

The present invention discloses a handheld device capable of independently actuating camera and method thereof. The handheld device comprises an input module, a storage module, a mobile phone module and a camera module. The input module has a first button and a second button. The storage module is connected to the input module and stores a first operating system and a second operating system. The mobile phone module is connected to the storage module and provides a mobile phone function. The camera module is connected to the storage module and provides a camera function. When the first button is pressed, the first operating system is activated for enabling the mobile phone module to provide the mobile phone function. When the second button is pressed, the second operating system is activated for enabling the camera module to provide the camera function.

### FIELD OF THE INVENTION

The present invention is related to a handheld device capable of independently actuating camera and a method thereof, and particularly to directly operate the camera module to provide camera function without actuating the mobile phone module of the handheld device.

### BACKGROUND OF THE INVENTION

Currently, many handheld devices, such as mobile phones or personal digital assistants are provided with extremely high quality camera modules and camera functions which can bring users great convenience. However, the function camera module could not work until the operating system of a handheld device is activated completely, so that the operating system drives a lot of unnecessary components simultaneously, and thus causes the power loss of the handheld device. Accordingly, how to independently actuate the camera module to enable the camera function quickly and reduce the power consumption of handheld device is an urgent problem to be solved.

Referring to FIG. 1 for a schematic diagram of a mobile communication device having a camera in prior art, the mobile communication device 1 comprises a mobile communication module 11, a camera module 12, a storage module 13, a display module 14 and a switching module 15. The camera module 12 can output processed image data through a second transmission interface 121, and the mobile communication module 11 receives the processed image data through a first transmission interface 111, and transmits the received image data to the storage module 13 for storing and to the display module 14 for display. Furthermore, the switching module 15 is installed in the mobile communication module 11 for switching the mobile communication device 1 to operation of the camera module 12 or the operation of mobile communication module 11. However, the defects of the above prior art are that the mobile communication device 1 can neither actuate the camera module 12 independently and activate the camera function of the camera module 12 quickly, nor reduce the power loss of the mobile communication device 1.

As a result of a variety of extensive and intensive studies, designs and discussions to the subject to solve the defects of the prior art and satisfy the user's requirements for a handheld device, the inventors propose a handheld device capable of independently actuating camera and a method of independently actuating the camera based on their research for many years and plenty of practical experience, thereby accomplishing the foregoing expectations.

### SUMMARY OF THE INVENTION

Thereof, one of the objectives of the present invention is to provide a handheld device capable of independently actuating camera and a method thereof, and particularly, a camera module which can be directly actuated to provide the camera function without actuating the mobile phone module of the handheld device, for satisfying the user's requirements for the handheld device and solving the defects of the prior art. Therefore, not only the camera module can be actuated independently and the camera function can be activated quickly, but also power consumption of handheld device can be reduced.

Accordingly, to achieve the above objective, the present invention provides a handheld device capable of independently actuating camera. The handheld device comprises an input module, a storage module, a mobile phone module and a camera module. The input module has a first button and a second button. The storage module is connected to the input module and used for storing a first operating system and a second operating system. The mobile phone module is connected to the storage module and used for providing a mobile phone function. The camera module is connected to the storage module and used for providing a camera function. When the first button is pressed, the first operating system is activated for operating the mobile phone module to provide the mobile phone function. When the second button is pressed, the second operating system is activated for operating the camera module to provide the camera function.

Preferably, the input module can further comprise a third button which is used for activating the second operating system after the first operating system is activated.

Besides, the present invention further provides a method of independently actuating a camera of the handheld device, and the handheld device comprises an input module, a storage module, a mobile phone module and a camera module, the method comprising the following steps of:

i) installing a first button and a second button in the input module, and storing a first operating system and a second operating system in the module;

ii) activating the first operating system when the first button is pressed, or activating the second operating system when the second button is pressed; and

iii) operating the camera module in the second operating system to provide a camera function; and

operating the mobile phone module in the first operating system to provide a mobile phone function.

Preferably, the method further comprises the follow steps of:

iv) installing a third button in the input module; and

v) activating the second operating system when the third button is pressed after the first operating system is activated.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1 is a schematic diagram of a mobile communication device having a camera in the prior art.

FIG. 2 is a schematic diagram of a handheld device capable of independently actuating camera in accordance with the present invention; and

FIG. 3 is a flow chart showing a method of independently actuating a camera of handheld device in accordance with this invention.

### DETAILED DESCRIPTION OF THE PREFERRED EMBODIMENTS

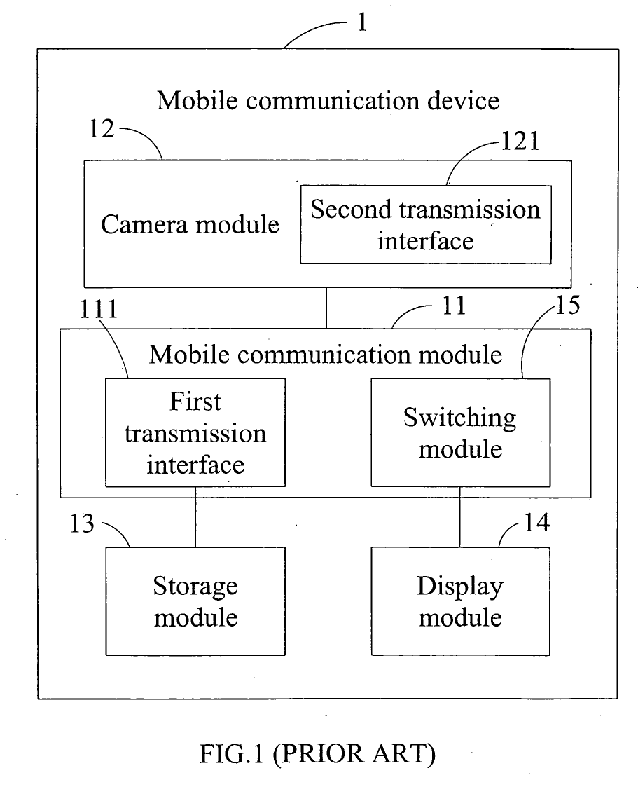

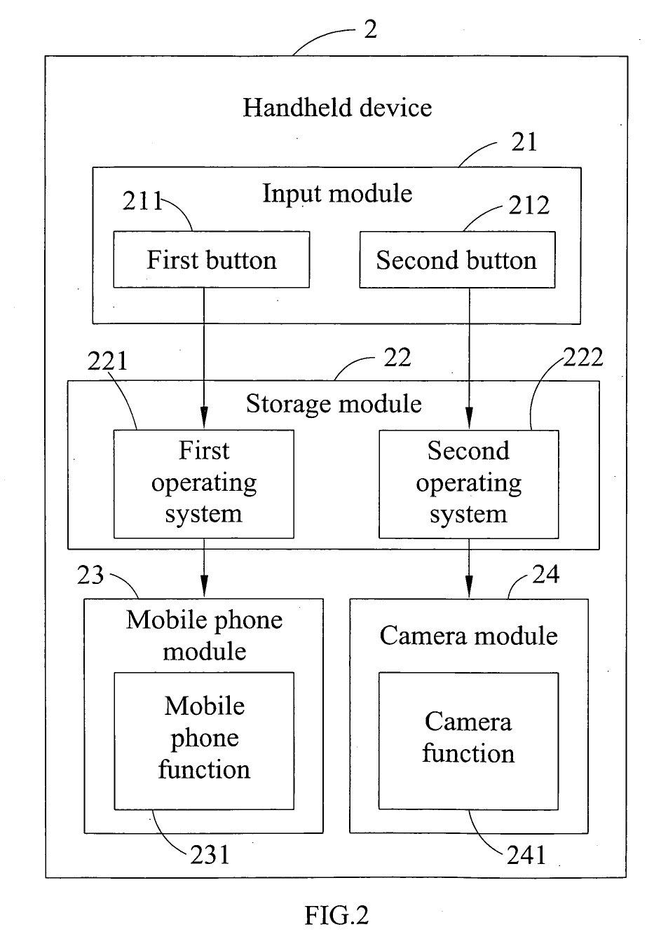

FIG. 2 illustrates a schematic diagram showing a handheld device capable of independently actuating camera in accordance with the invention. The handheld device 2 comprises an input module 21, a storage module 22, a mobile phone module 23 and a camera module 24. Preferably, the handheld device 2 can be one of a mobile phone and a personal digital assistant. The input module 21 has a first button 211 and a second button 212. The storage module 22 is connected to the input module 21 and used for storing a first operating system 221 and a second operating system 222. The first operating system 221 is designed for operating mobile phone module 23, and will initialize the RF module and wireless communication unit after being activated. The second operating system 222 is designed for operating camera module 24, and will initialize the lens driving unit, CCD or CMOS module, and image process unit after being activated. The first operating system 221 and second operating system 222 can be executed by a processor (not shown in FIG. 1), or executed by the mobile phone module 23 and the camera module 24 respectively.

The storage module 22 includes preferably one of a flash memory, a disk drive and any kind of storage media. Furthermore, the mobile phone module 23 is connected to the storage module 22 and operable to provide a mobile phone function 231, such as wireless communication and message receiving/transmitting. The camera module 24 is connected to the storage module 22 and operable to provide a camera function 241, such as image capture and video record.

When the first button 211 is pressed, the first operating system 221 is activated for enabling the mobile phone module 23 to provide the mobile phone function 231. Alternatively, the user may directly press the second button 212 to activate the second operating system 222 for enabling the camera module 24 to provide the camera function 241, and then the user can use the handheld device 2 to take a picture while the mobile phone module 23 is disable, so the power consumption becomes less.

In addition, the input module 21 can further comprise a third button if necessary. The third button is configured to activate the second operating system 222 after the first operating system 221 is activated. Namely, after the user presses the first button 211 to activate the first operating system 221 for operating the mobile phone module 23 to provide the mobile phone function 231, the user can further press the third button to activate the second operating system 222 for operating the camera module 24 to provide the camera function 241. In this situation, the user can use the handheld device 2 to take a picture while operating the mobile phone module 23 is operating.

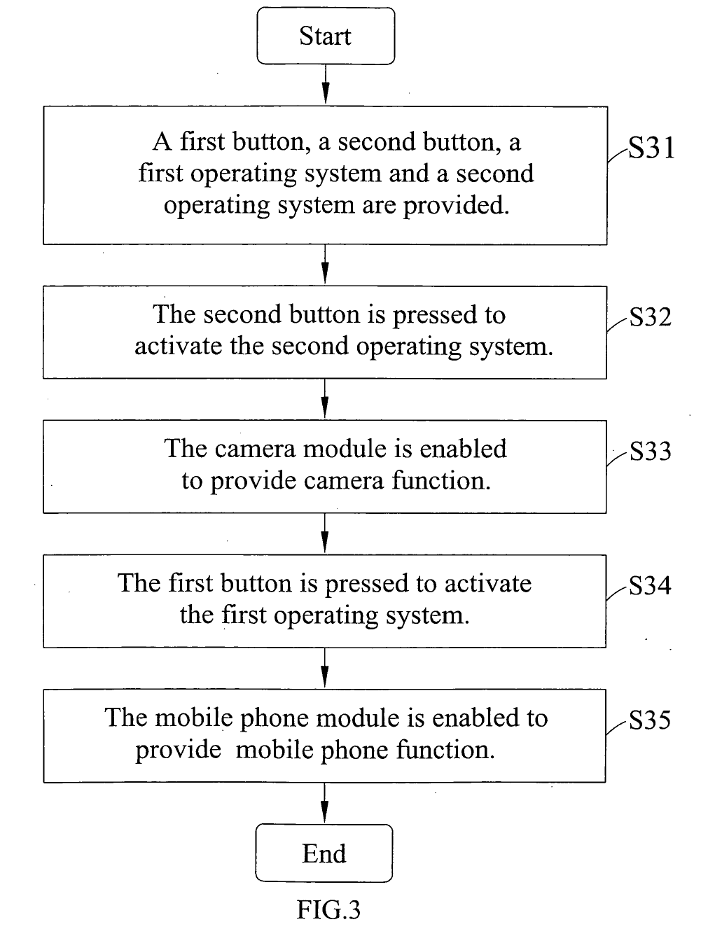

Referring to FIG. 3 for a flow chart of a method of independently actuating a camera of a handheld device in accordance with the present invention, this method corresponds to the handheld device 2 shown in FIG. 2, and comprises the following steps.

In step S31, a first button 211 and a second button 212 are installed in the input module 21, and a first operating system 221 and a second operating system 222 are stored in the storage module 22. Preferably, the storage module 22 includes one of a flash memory, a disk drive and any kind of storage media.

When the second button 212 is pressed by a user, the second operating system 222 is activated in step S32, and the camera module 24 is directly enabled to provide camera function 241 in the second operating system 222 in step 33. For example, during activation of the second operating system 222, the lens unit, image sending unit and image process unit of the camera module 24 are initialized and enabled for capturing image.

When the first button 211 is pressed by a user, the first operating system 221 is activated in step S34, and the mobile phone module 23 is directly enabled to provide the mobile phone function 231 in the first operating system 221 in step 35. For example, during activation of the first operating system 221, the RF module and wireless communication unit of the mobile phone module 23 are initialized and enabled for wireless communication.

Besides, a third button can further be installed in the input module 21 for activating the second operating system 222 after the first operating system 221 is activated. Therefore, the user can operate the handheld device 2 for both image capture and wireless communication.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handheld device capable of independently actuating camera comprising:
an input module having a first button and a second button;
a storage module connected to the input module and for storing a first operating system and a second operating system;
a mobile phone module connected to the storage module and for providing a mobile phone function; and
a camera module connected to the storage module and for providing a camera function;
wherein, when the first button is pressed, the first operating system is activated for operating the mobile phone module to provide the mobile phone function, or when the second button is pressed, the second operating system is activated for operating the camera module to provide the camera function.

2. The handheld device as claimed in claim 1, wherein the handheld device can be one of a mobile phone and a personal digital assistant.

3. The handheld device as claimed in claim 1, wherein the input module further comprises a third button which is used for activating the second operating system after the first operating system is activated.

4. The handheld device as claimed in claim 1, wherein the storage module includes one of a flash memory, a disk drive and any kind of storage media.

5. A method of independently actuating a camera of a handheld device, and the handheld device comprising an input module, a storage module, a mobile phone module and a camera module, and the method comprising the following steps of:
installing a first button and a second button in the input module, and storing a first operating system and a second operating system in the module;
activating the first operating system when the first button is pressed, or activating the second operating system when the second button is pressed;
operating the camera module in the second operating system to provide a camera function; and
operating the mobile phone module in the first operating system to provide a mobile phone function.

6. The method as claimed in claim 5, wherein the handheld device can be one of a mobile phone and a personal digital assistant.

7. The method as claimed in claim 5, further comprising the following steps of:
Installing a third button in the input module; and
activating the second operating system when the third button is pressed after the first operating system is activated.

8. The method as claimed in claim 5, wherein the storage module includes one of a flash memory, a disk drive and any kind of storage media.
